(19) United States
(12) Patent Application Publication
(10) Pub. No.: US 2025/0342480 A1
(43) Pub. Date: Nov. 6, 2025

(54) RFID-Enhanced Point-of-Sale Transactions

(71) Applicant: Automaton, Inc., San Diego, CA (US)

(72) Inventor: Spencer Hewett, New York, NY (US)

(73) Assignee: Automaton, Inc., San Diego, CA (US)

(21) Appl. No.: 19/197,350

(22) Filed: May 2, 2025

Related U.S. Application Data
(60) Provisional application No. 63/641,797, filed on May 2, 2024.
(60) Provisional application No. 63/642,315, filed on May 3, 2024.

(51) Int. Cl. G06Q 20/40; G06K 7/10; G06V 10/75; G06V 20/52

(52) U.S. Cl. CPC G06Q 20/407; G06K 7/10415; G06V 10/751; G06V 20/52

(57) ABSTRACT

Systems and methods for automated processing of item returns are disclosed. A method includes detecting, by a processor, that an item has been placed into a container. The processor may detect that the item has been placed into the container using one or more of computer vision, sensors, and/or RFID tag signals received from an RFID tag attached to the item. An RFID tag reader transmits first signals to the RFID tag and receives a response to the first signals from the RFID tag. The processor determines transaction data associated with the item based on the RFID tag response, including purchase amount, payment method, and purchase date. The processor then at least partially refunds an amount in response to the transaction data.

### CROSS REFERENCE TO RELATED APPLICATIONS

This application claims the priority benefit, under 35 U.S.C. 119 (c), of U.S. Application No. 63/642,315, entitled “RFID-based Checkout Compliance” and filed May 3, 2024, and of U.S. Application No. 63/641,797, entitled “RFID-based Returns” and filed May 2, 2024, each of which is incorporated herein by reference in its entirety for all purposes.

### BACKGROUND

Radio-frequency identification (RFID) tags, or tags, are low-cost devices that can be attached to objects and offer the promise of automated tracking, locating, sales check-out, and inventory of the objects among other commercial, industrial, and medical applications. There are passive, semi-active, and active types of RFID tags that can be wirelessly interrogated by an RFID tag reader, also called a tag reader, RFID reader, reader, or sensor, and emit wireless RF replies to the reader. Each reply can include information stored in the RFID tag, such as a tag identification number, an electronic product code (EPC), or other unique alpha-numeric sequence or identifier. Other information may be included with the reply.

Passive RFID tags have no battery and are therefore typically less expensive than semi-active and active RFID tags. A passive RFID tag is powered by an unmodulated, continuous-wave RF signal from the RFID tag reader. This continuous-wave RF signal powers up the passive RFID tag's circuitry and precedes a query or command from the RFID tag reader in the form of a modulated RF signal. The passive RFID tag receives and demodulates the modulated RF signal and responds to the RFID tag reader by modulating and backscattering an unmodulated portion of the RF signal from the RFID tag reader. This modulated, backscattered RF signal is the passive RFID tag's reply to the query or command and is detected by the RFID tag reader. The replies from passive RFID tags are typically many orders of magnitude weaker than the RF signals from the RFID tag readers. This makes the replies more difficult to detect at longer ranges and limits the range of passive RFID tags.

Each cycle of transmitting a continuous-wave (cw) RF signal and a query or command to the tag and receiving the tag's reply is called a hop. The cw RF signal and query or command for each hop can be at a different carrier frequency, i.e., a reader can hop among carrier frequencies within a particular frequency band as it interrogates different tags. Many tags can respond during a single hop, but the FCC regulates the maximum duration of a hop, so a reader can repeat hops periodically until it has read all of the tags within range if the tag population is too large to be read within a single hop. The reader can continue to query the tags within range periodically, for example, to monitor inventory of the items the tags are attached to.

The readers can be used to estimate the tag's location in three dimensions using one of several techniques. For instance, each reader may detect the amplitude or power of the tag's reply in addition to the unique modulation (e.g., the EPC) that identifies which tag is replying to the query. In other words, each sensor can record a received signal strength indicator (RSSI) for each tag within range. If the reader has an antenna array that can sense the angle-of-arrival (AOA) of the tag's reply, the reader can record the AOA in addition to or instead of the RSSI. An appliance or central controller coupled to the sensors can use the measured RSSIs and/or AOAs to estimate the tag's position.

### SUMMARY

RFID tags may be used in retail settings for inventory management (including stocking and restocking, shelving and reshelving, ordering replacement inventory, sales strategies, etc.), item tracking, automated item checkout, and more. However, typical state-of-the-art systems lack functionality enabling a customer to process a return without interacting with a sales associate or other employee, which can lead to delays and frustration for the customer.

The inventor has recognized and appreciated the benefit of utilizing RFID tags attached to items to process returns of those items without a sales associate, which may provide marked improvements to the customer return experience. Optionally, the systems and methods described herein may utilize computer vision (CV) or other detection methodologies to supplement RFID detection of RFID tags attached to items. CV and other detection methodologies may include pose estimation, trajectory tracking, appearance-based signatures, weight or pressure sensors, laser sensors, or any other suitable methodologies.

These systems and methods include systems that can be used for automated processing of item returns. Such a system may comprise a container, a sensor, an RFID tag reader, and a processor. In operation, the container receives an item being returned. The sensor senses that the item has been placed into the container. The RFID tag reader, which is operably coupled to the sensor (e.g., via the processor), (i) queries an RFID tag attached to the item in response to the sensor sensing that the item has been placed into the container and (ii) receives a response to the query from the RFID tag. And the processor, which is operably coupled to the sensor and the RFID tag reader, determines transaction data associated with the item based the response and at least partially refunds an amount based on the transaction data, which can indicate a method of payment associated with a purchase of the item, such as a bank account, a credit card, a debit card, and/or an amount of currency.

The sensor can include a camera that acquires image data showing the item being placed into the container. The processor analyzes this image data, e.g., by identifying a voxel at least partially overlapping the container and detecting a portion of a person and the item within the voxel. The sensor could also include a weight sensor that senses a change in the weight of the container's contents. Or it could include a motion sensor configured to sense movement of the item into the container.

The system can also include a user interface that is operably coupled to the processor. In operation, the user interface displays information associated with the transaction data, such as a method of payment associated with the transaction data, information corresponding to a person associated with the transaction data, the amount at least partially refunded, or a date associated with the transaction data. The user interface can also receive confirmation of the transaction data and/or an authentication, e.g., of the user's identity. This confirmation may include one or more of: a method of payment associated with a purchase of the item; a name of the person associated with the purchase of the item; an address of the person associated with the purchase of the item; a zip code associated with the method of payment; a date associated with the purchase of the item; or a description of the item.

Other inventive methods and systems monitor and facilitate checkout transactions. For instance, an RFID tag reader may detect RFID tags moving through a store. The RFID tag reader can detect these RFID tags by transmitting interrogation signals to the RFID tags and detecting the RFID tags' replies to the interrogation signals. These replies can be used to determine channel estimates for the RFID tags; noise properties of the channel estimates and/or changes in the channel estimates over time can be used to determine that the RFID tags are moving. A processor or appliance integral with or operably coupled to the RFID tag reader associates items affixed to the RFID tags with a cluster. When a point-of-sale (POS) system detects a first item in the cluster, the POS system provides an indication of other items in the cluster to the person checking out the first item.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates a point-of-sale (POS) system integrated with a camera and one or more ceiling-mounted RFID tag readers for automated processing of an item return in accordance with the present technology.

FIG. 1B illustrates a POS system with a weight sensor, a motion sensor, and an RFID tag reader and integrated with a camera for automated processing of an item return in accordance with the present technology.

FIG. 2 illustrates an example method of automated processing of an item return with an RFID-enabled POS system.

FIG. 3 illustrates an example method of automated checkout compliance with an RFID-enabled POS system.

FIG. 4 illustrates an RFID tag reader in greater detail, including components that can be enabled or disabled if the RFID tag reader is in interrogator mode or listener mode.

### DETAILED DESCRIPTION

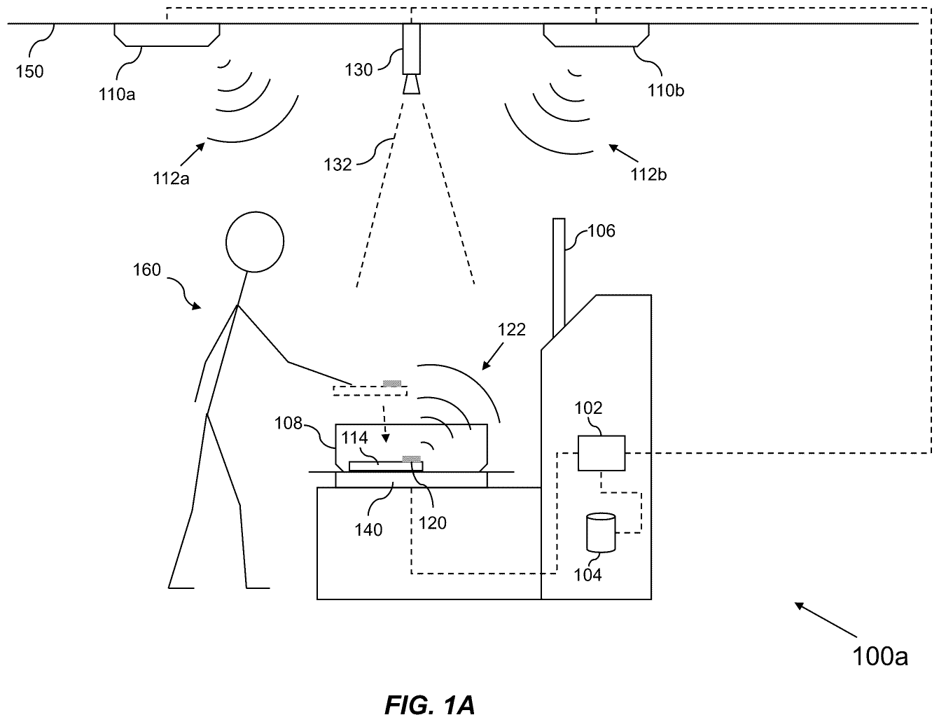

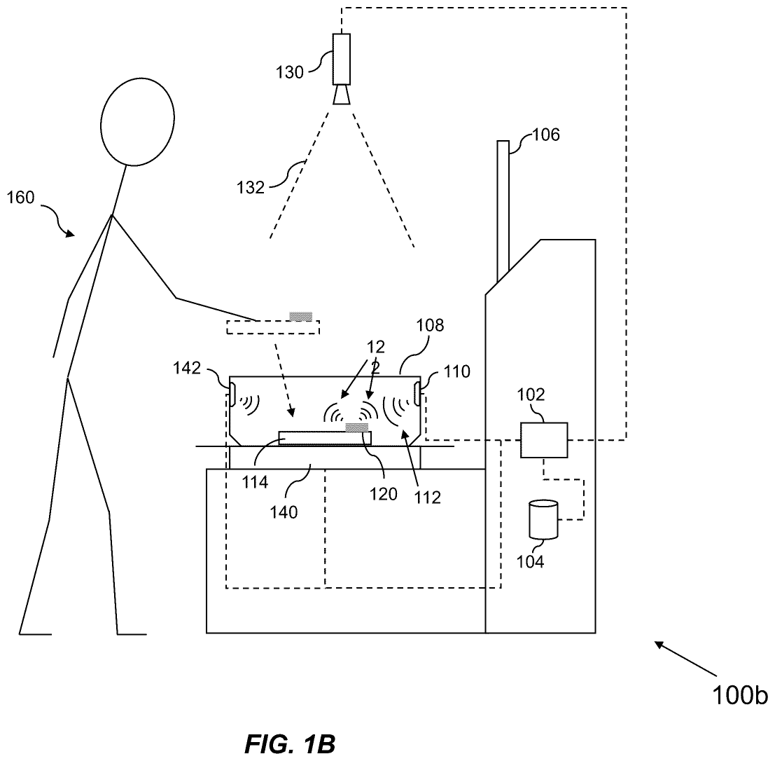

FIG. 1A illustrates an RFID-enabled point-of-sale (POS) system 100a for automated processing of an item return in accordance with the present technology. System 100a may include at least one processor 102 communicatively coupled to components within system 100a and configured to perform a variety of tasks, calculations, analyses, and determinations. Processor 102 may be or include a microprocessor, a central processing unit (CPU), a distributed computing system, a graphics processing unit (GPU), a field-programmable gate array (FPGA), an application-specific integrated circuit (ASIC), or any suitable processing device. Processor 102 can also be located in a separator appliance or central controller that is connected to or part of the system 100a. This appliance or central controller can be used to communicate with and/or control one or more RFID tag readers 110 (described below).

Processor 102 may include or be coupled to a memory, such as random-access memory (RAM), dynamic random-access memory (DRAM), flash memory, or any suitable type of memory for short-term (volatile) or long-term (non-volatile) data storage. Processor 102 may be communicatively coupled to a storage 104, which may be a hard disk drive (HDD), solid-state drive (SSD), cloud storage, or any suitable type of non-volatile storage for storing data over long periods of time. Storage 104 is depicted as integral to system 100a but could also be or include a separate database or data store that is coupled to system 100a via the internet or another suitable computer network.

Storage 104 may store transaction data, sales data, personal data, financial data, radio-frequency identification (RFID) data (such as RFID tag data, items associated with respective RFID tags, locations of RFID tags, RFID tag readers, RFID tag reader locations, etc.), data related to system 100a, or any suitable data. Examples of data stored on storage 104 may include an identifier (e.g., an item number, stock keeping unit (SKU), manufacturing company, item model, item description, etc.) of an item that has been previously sold as well as the date of sale, transaction amount (e.g., an amount of money paid, debited, or credited for the item), payment method (e.g., bank account, credit card number, debit card number, currency denominations used to purchase the item, cryptocurrency address, cryptocurrency ledger entry, blockchain entry, financial institution account for a retailer, etc.), information about a person associated with the payment method (e.g., name of the person who owns the payment method, billing address, billing zip code, credit score, social security number, prior transactions, manually entered notes, etc.), RFID data described above (e.g., EPC), components of system 100a detected by processor 102, or any suitable data.

System 100a may include a user interface or display 106, which may be a touchscreen or other suitable display configured to provide visual, audio (via one or more speakers), or other suitable information. Display 106 may be configured to receive input from a person 160 associated with item 114 (e.g., a person carrying item 114 or a person who places item 114 in a container 108 or, equivalently, in a transaction area, such as on a shelf) or may be coupled to a separate device, such as a touchpad, keypad, keyboard, etc., that can receive input from person 160. In some instances, person 160 may be a person who previously purchased item 114; however, person 160 does not need to be a person who previously purchased item 114. A user interface of display 106 may include one or more speakers, microphones, buttons, knobs, dials, touchscreen buttons, sliders, switches, cameras, fingerprint scanners, biometric sensors, or other suitable features.

System 100a also includes a camera 130, which is operably coupled to processor 102. Camera 130 may be placed above, besides, or in any suitable location relative to container 108 (or an equivalent transaction area) such that its field of view (FoV) 132 encompasses at least an interior of or opening into container 108 as well as a portion of an environment surrounding container 108. For example, camera 130 may have an FoV 132 that includes container 108, the interior of the container 108, an opening or aperture in the container 108, display 106, an area in front of container 108 where a person 160 may stand, or the like. Display 106 can show image data captured by camera 130 to person 160, possibly with other information, including information about the item(s) in the container 108, i.e., the item(s) being returned, information about the original purchase, and/or information about the return.

In operation, processor 102 may determine that an item 114 has been placed in container 108 by analyzing image data captured by one or more cameras such as camera 130. Processor 102 may utilize image data captured by camera 130 to determine that item 114 has been placed in container 108 by performing computer vision processing on the image data, for example, by using edge detection, pose estimation, feature extraction, segmentation, and the like. Processor 102 may identify one or more volume pixels (voxels) associated with a volume including, at least partially overlapping, within, or around container 108. Processor 102 may determine, based on the image data, that a portion of person 160 such as a wrist or hand has moved into a voxel associated with container 108. Processor 102 may further determine that an item 114 was being held by person 160 (e.g., image data representing item 114 was contiguous with image data representing a hand and/or wrist of person 160) when item 114 and a portion of person 160 entered the voxel, but that item 114 did not exit the voxel when the portion of person 160 exited the voxel. Processor 102 may further determine that item 114 has been placed in container 108 based on a comparison of image data of container 108 when it is empty.

System 100a may further include or be coupled to one or more RFID tag readers, including a first RFID tag reader 110a and a second RFID tag reader 110b (collectively, RFID tag readers 110). RFID tag readers 110 may be disposed in a suitable location such as on ceiling 150 or within container 108 (as shown in FIG. 1B, described below). Each RFID tag reader 110 may include circuitry configured to query RFID tags such as RFID tag 120 disposed on item 114. RFID tag readers 110 may include one or more processors, one or more memories, one or more antennae, one or more power sources (e.g., a battery, a Power-over-Ethernet connection to a central controller, a connection to facility power such as a 120 V outlet, or any suitable power source). First RFID tag reader 110a and second RFID tag reader 110b may be configured to transmit first signals 112a and second signals 112b, respectively, to one or more RFID tags such as RFID tag 120 and to detect or sense responses from RFID tag 120 to those signals.

In response to determining that an item 114 has been placed in container 108, processor 102 may command first RFID tag reader 110a and/or second RFID tag reader 110b to transmit one or more queries in the form of first signals 112a and/or second signals 112b, respectively, to RFID tag 120. In response to first signals 112a, second signals 112b, or other query signals from RFID tag readers 110, RFID tag 120 may transmit a response 122. Response 122 may include information stored by RFID tag 120 such as tag ID number, EPC, alphanumeric sequence or code, or the like. RFID tag readers 110 may detect and demodulate response 122 and forward, transmit, or otherwise communicate information encoded in response 122, such as EPC, to processor 102.

Processor 102 may use the information encoded in response 122 to determine information about item 114 including transaction data, sales data, personal data, financial data, or any suitable information that could be used to identify item 114 and details about its purchase. Upon receiving response 122, processor 102 may determine if the RFID tag 120 is associated with an item that has been previously sold, for example, by performing a lookup of data stored by storage 104 and/or by querying a database (not shown) of old sales transaction. Processor 102 may determine from this information that RFID tag 120 is associated with item 114 and that item 114 was previously sold based on identifying information derived the response of RFID tag 140 to the query from the RFID tag reader(s) 110.

Additionally or alternatively to detecting an item 114 from image data, processor 102 may detect item 114 in container 108 based on one or more responses from RFID tag 120. For example, each RFID tag reader 110 may periodically broadcast interrogation signals to the RFID tags within range. If first RFID tag reader 110a and/or second RFID tag reader 110b receives a response 122 to such an interrogation signal from RFID tag 120, first RFID tag reader 110a and/or second RFID tag reader 110b can estimate the location of RFID tag 120 based on the response 122 as described below. And if the RFID tag readers 110 determine that the RFID tag 120 is in the container 108 based on response 122, the RFID tag readers 110 may trigger a lookup or query of transaction data for the item 114 affixed to the RFID tag 120 as explained above.

Processor 102 may determine additional information related to item 114 including prior sale of item 114, date item 114 was sold, sale price, transaction information (including person associated with the sale, payment method, transaction time, transaction location, associated discounts, taxes, associated bank accounts [e.g., of one or more of the customer and/or the retailer], fees, coupons, promotions, etc.), eligibility for return (e.g., if the item was purchased recently enough to be eligible for a return, refund, or exchange), if item 114 was reported stolen, or any suitable information.

Processor 102 may utilize display 106 to show information relevant to a return of item 114. For example, if processor 102 determines that RFID tag 120 is associated with a previously sold item 114, processor 102 may use display 106 to display a query to or request confirmation from person 160 about whether they intend to return item 114. Processor 102 may display a variety of information including whether item 114 is eligible for return, an amount to be refunded (which may be all or less than all of a purchase price of item 114), a payment method used to purchase item 114, a bank account, credit card, debit card, digital wallet, or other financial entity to which a refund amount will be transferred, a denomination of physical currency in which a refund will be given, information corresponding to a person who originally purchased item 114 (e.g., name, address, etc.), a date corresponding to the original purchase, an amount of tax charged during the original purchase, a coupon or promotion used during the original purchase, an offer to exchange an item 114 instead of returning and refunding item 114, or any suitable information.

Processor 102 may use display 106 to prompt person 160 for confirmation of information associated with the transaction data, or to authenticate that they are associated with an original purchase of item 114. For example, processor 102 may display the text “Please confirm the billing zip code of the payment method used to purchase the item” and additionally display a keyboard on a user interface through which person 160 may type an input. Person 160 may then type the zip code corresponding to the credit card used to purchase item 114, at which point processor 102 may proceed with transferring all or some of the purchase price to the credit card, thus completing the return. Confirmation of information associated with the transaction data and/or an authentication may include prompting the person 160 to provide information corresponding to information stored on storage 104 and retrieved by processor 102, such as transaction data, sales data, personal data, financial data, or any suitable information. Person 160 can provide this information via the display/user interface 106 or via another device, such as a smartphone with an app that can be triggered by the processor 102 or an appropriate server.

Examples of information that may be used as confirmation of stored information may include the method of payment associated with the transaction data, a name of the person associated with a purchase of the item, an address of the person associated with the purchase of the item, a zip code associated with the method of payment, a date associated with the purchase of the item, a description of the item, or the like.

Based on one or more of the transaction data, the response 122 from RFID tag 120, image data from camera 130, data stored on storage 104, and/or a confirmation and/or authentication from person 160, processor 102 may then trigger at least a partial refund of an amount of money corresponding to a transaction price of the item 114 using the payment method. For example, processor 102 may determine that an item 114 is eligible for a full refund of the original purchase price including any taxes and fees. Processor 102 may determine that an item 114 is eligible for a refund of only a portion of the original purchase price, for example, only 50% of the purchase price because a threshold number of days has elapsed since the date of purchase. Processor 102 may determine that a manufacturer's suggested retail price (MSRP) for an item 114 was $20, but the customer who purchased the item 114 used a coupon for 50% off and therefore only paid $10 plus tax. Processor 102 may therefore determine that only $10 plus the tax paid should be refunded to the customer using the payment method. Processor 102 can also trigger provision of store credit instead of a refund in response to detecting and confirming the return of an item.

FIG. 1B illustrates an alternative RFID-enabled POS system 100b for automated processing of an item return in accordance with the present technology. Like the system 100a shown in FIG. 1A, the system 100b shown in FIG. 1B includes a container 108 for receiving an item 114 being returned by a person 160. The system 100b also includes a processor 102 that is coupled to an RFID tag reader 110 for querying an RFID tag 120 affixed to the item 114 and a memory or data store 104 that stores transaction data associated with prior item sales/purchases. In this system 100b, the RFID tag reader 110 is attached to the container 108 and oriented to read RFID tags within the container 108. (The system 100b can also be operably coupled to other RFID tag readers 110, including ceiling-mounted RFID tag readers 110 like those in FIG. 1A). Placing the RFID tag reader 110 in container 108 may provide the benefit(s) of using less transmission power to read the tag 120 and/or increased sensitivity, both of which can be useful if the RFID tag 120 is more difficult to read, e.g., due to damage sustained after purchase.

System 100b also includes an optional scale or weight sensor(s) 140 arranged and configured to sense changes in weight of the contents of the container 108. For example, the container 108 may be disposed on or contain one or more weight sensor(s) 140 configured to determine the weight of the contents of the container 108 including any objects or items placed in container 108. For example, container 108 may be disposed on the weight sensor 140 or contain the weight sensor 140. In either case, processor 102 is communicatively coupled to the weight sensor(s) 140 and may determine if container 108 is empty or contains one or more items based on measurements from the weight sensor(s) 140.

Processor 102 may determine that an item has been placed into container 108 based on changes in the weight of the container 108 and/or its contents. For example, processor 102 may determine that container 108 is empty based on a first measurement from one or more weight sensors 140. When an item such as item 114 is placed in container 108, processor 102 may receive a second measurement from one or more weight sensors 140 indicating that the weight of the container's contents has increased. Processor 102 may compare the first measurement and second measurement and thereby determine that item 114 has been placed in container 108.

The system 100b can also include an optional motion sensor 142, such as an infrared motion sensor, that senses movement into (and out of) the container 108. The motion sensor can be mounted in, on, or above the container 108. If the container 108 is sealed or has a lid, the motion sensor can monitor whether the lid is opened or closed. Similarly, if the container 108 has a slot, opening, or aperture for receiving returned items, the motion sensor can detect motion of an object through the slot and into the container 108. In response to detecting motion, the motion sensor 142 sends a signal to the processor 102, which determines that item 114 has been placed in container 108 based on the signal.

If desired, the system 100b can also include or be coupled to a camera 130 that monitors the container 108 as explained above with respect to FIG. 1A.

The processor 102 is operably coupled to the weight sensor 140, motion sensor 142, and camera 130 and uses signals from any or all of these sensors to determine if a person 160 has placed an item 114 for return in the container 108. If the processor 102 determines that the item 114 has been added to the container 108, it commands or triggers the RFID tag reader 110 to query the RFID tag 120 affixed to the item 114. The processor 102 uses information encoded in the RFID tag's reply to the query to look up transaction data about the original sale of the item 114 in memory 104 or another data store communicatively coupled to the processor 102 as explained above. The processor 102 uses this transaction data to identify the item 114, verify the original sale, and issue a refund or store credit as appropriate.

### Processing Returns Using an RFID-Enabled POS System

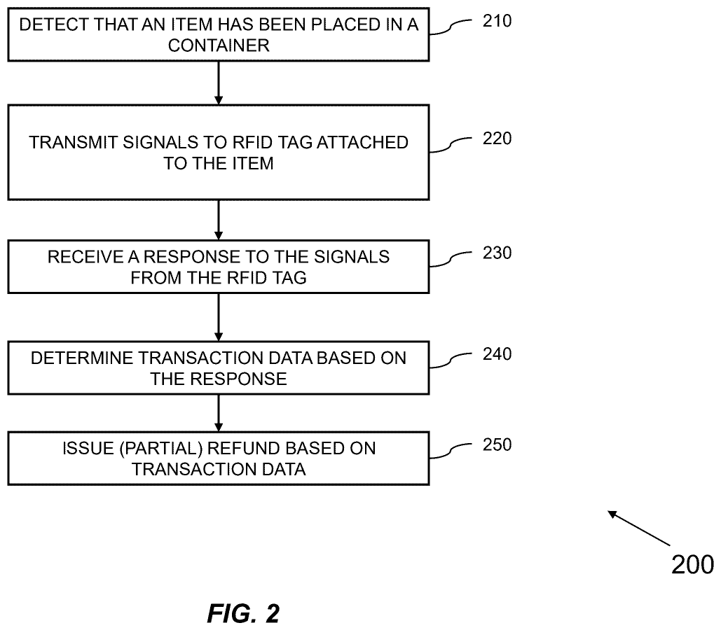

FIG. 2 illustrates a flowchart of an example method 200 for automated processing of an item return. Method 200 includes blocks 210-250, each of which may be performed by a suitable component of system 100a, system 100b, and/or RFID tag reader 110 as appropriate.

At block 210, a sensor (e.g., a scale, camera, or motion detector) detects that an item has been placed into a container. The processor may detect that the item has been placed into the container by any one or more of analyzing image data received from a camera indicating the item being placed into the container, comparing a weight of the container and/or its contents before the item has been placed into the container with a weight of the container and/or its contents after the item has been placed into the container, receiving a signal from a motion detector, and/or receiving a signal from the RFID tag by an RFID tag reader.

At block 220, an RFID tag reader communicatively coupled to the processor transmits one or more signals to an RFID tag attached to the item. The RFID tag responds to these signals by transmitting a response modulated with its EPC or another suitable identifier. The RFID tag reader detects and demodulates the response and transmits the RFID tag's EPC to the processor (block 230), which uses the EPC to query a sales database for transaction data about the sale of the item attached to the RFID tag.

At block 240, the processor determines transaction data associated with the item based on the first response. For example, the processor may perform a lookup of data (e.g., in a database) stored on a suitable storage to determine if the information contained in the response from the RFID tag is associated with transaction data. The processor may determine that the information contained in response from the RFID tag is linked to a transaction for a purchase of the item on a particular date. The transaction data may include a method of payment associated with the transaction data, information corresponding to a person associated with the transaction data, an amount paid for the item, an amount eligible to be at least partially refunded, and/or a date associated with the transaction data.

At block 250, the processor at least partially refunds an amount based on the transaction data. The processor may refund (equivalently, reverse, return, or give store credit for) a sale transaction by transferring an amount of money from an initial recipient (e.g., the store) to the initial purchaser (e.g., the customer). The processor may utilize the method of payment to process the refund. A method of payment may include at least one of a bank account, a credit card, a debit card, a cryptocurrency address, a digital wallet ID or address, and/or an amount of currency. An amount at least partially refunded may utilize a plurality of methods of payment. Prior to at least partially refunding the amount based on the transaction data, the processor may receive a confirmation and/or authentication from a person associated with the item. The processor may utilize a display including a user interface to present a person associated with the item with information and receive a corresponding response. The confirmation and/or authentication may include one or more of the method of payment associated with the transaction data, a name of the person associated with a purchase of the item, an address of the person associated with the purchase of the item, a zip code associated with the method of payment, a date associated with the purchase of the item, and/or a description of the item.

### Detecting and Clustering Moving RFID Tags for Checkout Compliance

An RFID-enabled POS system can also be used for ensuring that customers purchase all of the items that they have picked up before leaving the checkout area. In addition to querying RFID tags attached to items being returned, RFID tag readers 110 also query and track RFID tags attached to items for sale as they move about the store, including to the checkout. For example, a ceiling-mounted RFID tag reader 110 may broadcast query signals to RFID tags within range on a periodic basis, e.g., every second or every few seconds. Each RFID tag responds to the query signal by transmitting its EPC and/or other unique identifying information. The RFID tag readers receive these responses and use them to track inventory of items in the store.

RFID tag readers can also use these responses to estimate the locations of the RFID tags using one or more of a variety of methods. For instance, if multiple RFID tag readers receive responses from a given RFID tag, each RFID tag reader can compute the angle-of-arrival (AOA) of the response that it detected and provide that AOA to a central appliance or interrogator controller, which triangulates the RFID tag's position from the AOAs. Likewise, the RFID tag readers can also measure the amplitudes of detected responses and provide received signal strength indicators (RSSIs) to the central appliance or interrogator controller for trilaterating the RFID tag's position.

In other cases, an RFID tag reader 110 may use a channel estimate derived from an RFID tag's response to determine whether that RFID tag has moved since it was last queried. The channel estimate represents the scattering, fading, interference, and/or other effects that characterize the communications channel between the RFID reader 110 and the RFID tag 120. The channel estimate can be parameterized by RFID reader 110, carrier frequency, beamforming sector, interrogation signal amplitude, and/or other degrees of freedom associated with the interrogation signal, for each communications channel.

If each channel estimate is unique and the communications channels remain relatively static and independent of the individual tags' characteristics, then a channel estimate can be used as a fingerprint that identifies the corresponding communications channel. And if the locations of the endpoints of each communications channel—i.e., the locations of the RFID tag reader and tag—are known, then the channel estimate can be mapped to those locations. Similarly, if there are no changes in the communications channel between queries or measurements, then the channel estimate should remain constant. If the channel estimate changes from one measurement or query to another, the RFID tag reader may interpret that change to indicate that the RFID tag has moved between measurements or queries. For more on using channel estimates to locate RFID tags, please see International Application No. PCT/US2024/020357, entitled “Channel Estimation for Locating RFID Tags” and filed on Mar. 18, 2024, which is incorporated herein by reference in its entirety for all purposes.

The RFID tag readers 110 can use these techniques to locate and track RFID tags that have been picked up and are being carried around a store, shop, or other retail environment. For instance, an RFID tag reader may detect a pair of RFID tags at a first location in the store using AOA measurements. Sometime later, the same RFID tag reader or a different RFID tag reader may sense that the channel estimates associated with these RFID tags is changing at the same time/rate, indicating that the RFID tags are moving. Locating the RFID tags using AOA measurements, channel estimates, and/or computer vision or other information may reveal that the RFID tags are moving along the same trajectory or path, e.g., because they have been picked up and are being carried by a person through the store. That person may pick up (and/or put down) more items while walking through the store.

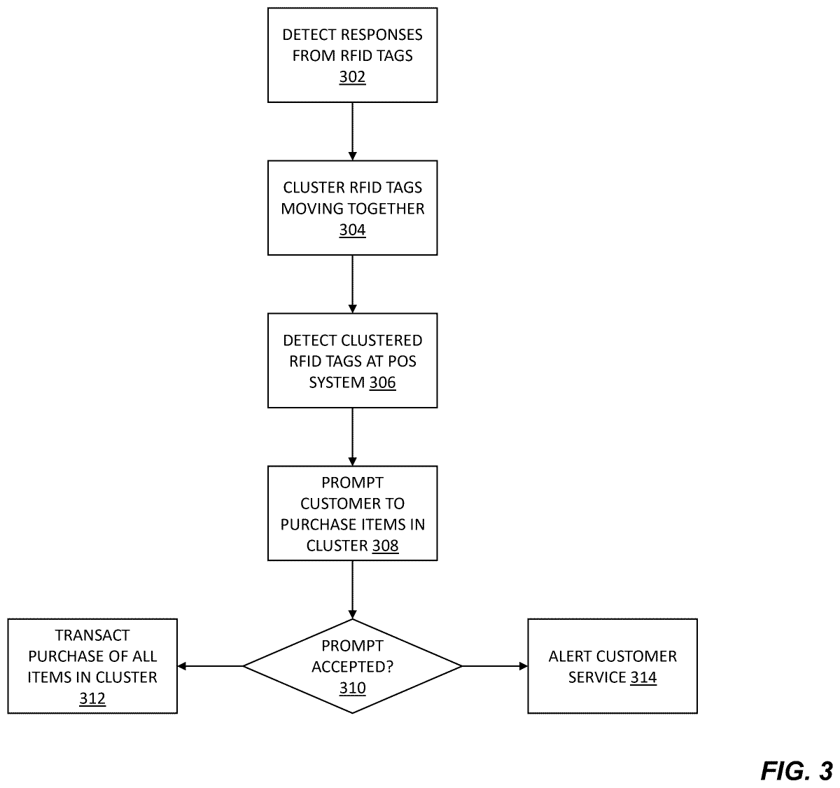

FIG. 3 illustrates how an RFID tag reader or an interrogator controller or appliance coupled to an RFID tag reader can cluster RFID tags that are moving together for checkout compliance at an RFID-enabled POS system like those shown in FIGS. 1A and 1B. If a customer, sales associate, or other person walking through a store picks up several items, one or more RFID tag readers may detect that the RFID tags attached to those items have channel estimates that are changing in a correlated manner (302). That is, the RFID tag reader(s) may determine that the channel estimates have similar or identical noise properties or that their estimated locations are changing at roughly the same speeds and/or by roughly the same amounts. If the RFID tag reader(s) determines that the RFID tags have channel estimates that are changing in a correlated fashion, then the RFID tag reader(s) may associate the RFID tags and the corresponding items in a cluster or group (304). Depending on the read rate (i.e., the rate at which the RFID tag reader(s) interrogates the RFID tags) and the accuracy with which the RFID tag reader(s) and/or appliance can estimate the RFID tags' locations, the RFID tag reader(s) and/or appliance may be able to estimate the RFID tags' (cluster's) trajectory through the store or other environment through which the RFID tags are moving and possibly estimate the RFID tags' destination (e.g., the checkout or exit). An RFID tag reader and/or appliance can group or cluster tags and the associated items even if the RFID tags' estimated locations are not perfectly coincident or their trajectories cannot be estimated.

If the customer wants to purchase the items, he or she may take the items to an RFID-enabled POS system (e.g., like those shown in FIGS. 1A and 1B), such as a self-checkout kiosk, that is operably coupled to the appliance. The POS system detects one of the items in the cluster (306), for example, because the person has scanned a bar code on the item with a bar code scanner that is coupled to or part of the POS system or because a RFID tag reader near or integrated with the POS system has located the item at the POS system. This detection causes the POS system to query the appliance about whether the item (or RFID tag attached to the item) is in a cluster. If the item is in a cluster, the appliance returns identifying information about the other RFID tags and/or items in the cluster. The POS system may use this identifying information to retrieve more information about the other items in the cluster.

If the POS system detects an end to the transaction before detecting that the other items in the cluster have been scanned, the POS system's user interface (e.g., display 106) can prompt the customer to purchase the other items in the cluster (308), e.g., by displaying or announcing a message to the customer (e.g., “You have scanned one item. What about the other items in your cart?”). This message can identify the other items in the cluster based on the EPCs of the corresponding tags. The customer can accept this prompt or decline or ignore this prompt (308).

If the customer accepts the prompt, the POS system can automatically add the remaining (unscanned) items from the cluster to the customer's tally for review and purchase (312). If the customer declines or ignores the prompt, or the customer requests help, the POS system can also alert a sales associate, cashier, or other store employee (314). The POS system can display the discrepancy between the (number of) scanned items and the (number of) items in the cluster, e.g., by flashing a light, playing a message or sound on a speaker, or sending an alert to the store employee's mobile device. Prompting the customer to scan the other items in the cluster or alerting the store employee can improve the customer's experience with the POS system and reduce theft and loss.

Alternatively, the POS system can automatically add all of the items in the cluster to the customer's tally and show the tally on the POS system's user interface (e.g., touchscreen or other display) in response to detection of one item in the cluster at the POS system. The customer can then purchase one or more of the items and place any of the items not being purchased in a re-stocking bin or area near the POS system. Automatically adding all of the items to the customer's tally eliminates the need to read or scan additional items (either with a bar-code scanner or an RFID tag reader), reducing checkout time and improving the customer's experience. It also reduces loss due to user error at the POS system, theft, or inadvertent removal of items from the store.

### RFID Tag Reader Architecture

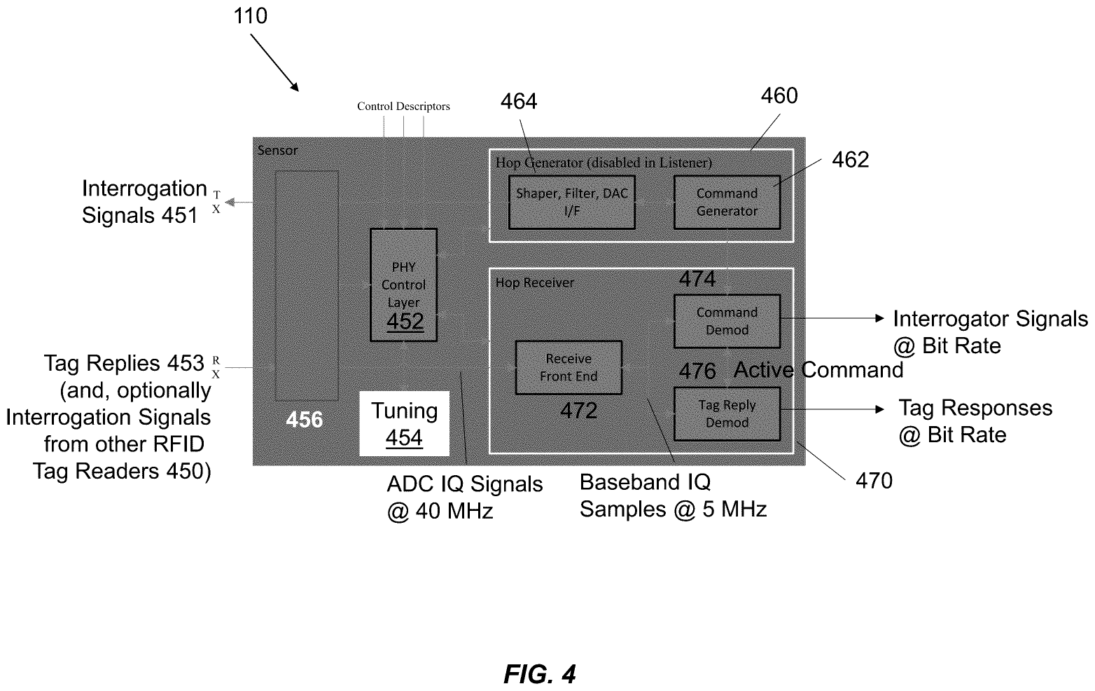

FIG. 4 illustrates an RFID tag reader 110 in greater detail, including components that can be enabled or disabled if the RFID tag reader 110 is in interrogator mode or listener/receive-only mode. The RFID tag reader 110 includes an RF antenna array and front end 456, a processor 452, an RF calibration and tuning block 454, a hop generator 460, and a hop receiver 470. The RF antenna array and front end 456 may include one or more antenna elements (e.g., arranged in a multi-element antenna array), amplifiers, filters, and/or other analog RF components for transmitting RFID interrogation signals 451 and receiving tag replies 453 and, optionally, RFID interrogation signals from other readers. The processor 452 may be implemented in a microcontroller, application-specific integrated circuit (ASIC), field-programmable gate array (FPGA), or other suitable device and controls the operation of the RFID tag reader 110, including, if desired, steering of the reader's antenna array. It stores information in and retrieves information from a memory (not shown) and communicates with the RFID tag 120 via a network connection (not shown), such as an Ethernet connection. If the RFID tag reader 110 is configured to operate in interrogator and listener modes, the processor 452 switches the RFID tag reader 110 between interrogator and listener modes, with the hop generator 460 being disabled or off in listener mode and enabled or on in interrogator mode and the hop receiver 470 being enabled or on in both modes. The RF calibration and tuning block 454 performs RF calibration and tuning functions.

The hop generator 460 generates the interrogation signals 451 that the RFID tag reader 110 transmits to one or more RFID tags 120. The hop generator 460 can optionally also generate commands or communications signals intended for other readers 110, e.g., on a dedicated reader communications channel or with particular preambles or payloads. It includes a digital command generator 462, which generates the digital queries, commands, and/or other information conveyed by the interrogation signals 451, and RF electronics 464 for turning the digital signals from the command generator 462 into analog signals suitable for transmission by the antenna array in the front end 456. The RF electronics 464 may include a digital-to-analog converter (DAC) that converts the digital signal into a baseband analog signal, a mixer and local oscillator to mix the baseband analog signal up to an intermediate frequency for broadcast, and filters and/or pulse shapers to remove sidebands and/or spurs.

The hop receiver 470 includes a receiver front end 472 coupled to a command demodulator 474 and a tag reply demodulator 476. Generally, the receiver front end 472 digitizes, downconverts, and estimates the phase of the RF signals detected by the antenna(s). There are a variety of ways to configure the receiver front end 472; in this example, it receives analog in-phase and quadrature (I/Q) signals at higher frequency (e.g., 40 MHZ) and converts them into digital I/Q samples at baseband (e.g., 5 MHZ).

In interrogator mode, the front end 472 also cancels any self-interference caused by the interrogation signals 451, for example, due to leakage within the receiver. Fortunately, the receiver front end 472 generally can cancel crosstalk between different antenna elements and the circuits coupled to those antenna elements because the crosstalk is correlated with the interrogation signal 451. This crosstalk can be further reduced or suppressed by spacing the antenna elements farther apart from each other as explained in U.S. Pre-Grant Publication No. 2024/0330619 A1, entitled “Antenna Arrays and Signal Processing for RFID Tag Readers,” which is incorporated herein by reference in its entirety for all purposes.

When the RFID tag reader 110 is in listener or receive-only mode, it does not transmit an interrogation signal, nor does it perform self-interference cancellation. In listener mode, the RFID tag reader 110 detects the channels on which the other readers 110 transmit interrogation signals 451 and estimates the frequencies of those other interrogation signals 451. For more on listener mode, please see U.S. Pre-Grant Publication No. 2024/0193381 A1, entitled “RFID Tag Readers Switchable Between Interrogator and Listener Modes,” which is incorporated herein by reference in its entirety for all purposes.

The command demodulator 474 is enabled when the RFID tag reader 110 is in listener mode and demodulates commands from other readers to reproduce the interrogator's signals at the command bit rate (e.g., 40 kbps to 160 kbps). The command demodulator 474 uses the command payload to determine what the reader in interrogator mode is asking of the RFID tag 120 (e.g., modulation, preamble type, expected reply type, etc.). For example, the RFID tag reader 110 in interrogator mode may ask the RFID tag 120 to send the first 64 bits of its EPC using Miller-2 modulation at 320 kHz backscatter link frequency (BLF) with the standard preamble. The RFID tag readers 110 in listener mode use that information to decode the tag reply 453. The command demodulator 474 is disabled when the RFID tag reader 110 is in interrogator mode.

The tag reply demodulator 476 is enabled in both interrogator and listener modes and demodulates the baseband tag reply I/Q samples to produce tag reply signals at the tag reply bit rate.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method for automated processing of an item return, the method comprising:
detecting, by a sensor, that an item has been placed into a container;
transmitting, using a radio-frequency identification (RFID) tag reader, a signal querying an RFID tag attached to the item;
receiving, by the RFID tag reader, a response to the signal from the RFID tag;
determining transaction data associated with the item based on the response; and
at least partially refunding an amount based on the transaction data.

2. The method of claim 1, wherein the transaction data indicates a method of payment associated with a purchase of the item, the method of payment comprising at least one of a bank account, a credit card, a debit card, or an amount of currency.

3. The method of claim 1, wherein the sensor comprises a camera and detecting, by the sensor, that the item has been placed into the container comprises:
analyzing image data acquired by the camera showing the item in the container.

4. The method of claim 3, wherein analyzing the image data comprises:
identifying, from the image data, a voxel at least partially overlapping the container; and
detecting a portion of a person and the item within the voxel.

5. The method of claim 1, wherein the sensor comprises a weight sensor and detecting, by the sensor, that an item has been placed into the container comprises:
detecting a change in weight of contents of the container.

6. The method of claim 1, wherein the sensor comprises a motion sensor and detecting, by the sensor, that the item has been placed into the container comprises:
sensing movement of the item into the container.

7. The method of claim 1, further comprising:
displaying information associated with the transaction data on a user interface associated with the container.

8. The method of claim 7, wherein the information associated with the transaction data comprises at least one of a method of payment associated with a purchase of the item, information corresponding to a person associated with the purchase of the item, the amount at least partially refunded, or a date associated with the transaction data.

9. The method of claim 8, further comprising:
receiving, via the user interface, at least one of a confirmation of the information or an authentication.

10. The method of claim 9, wherein the confirmation of the information comprises confirmation of at least one of:
the method of payment associated with the purchase of the item;
a name of the person associated with the purchase of the item;
an address of the person associated with the purchase of the item;
a zip code associated with the method of payment;
a date associated with the purchase of the item; or
a description of the item.

11. A system for automated processing of item returns, the system comprising:
a container configured to receive an item;
a sensor to sense that the item has been placed into the container;
a radio-frequency identification (RFID) tag reader, operably coupled to the sensor, to (i) query an RFID tag attached to the item in response to the sensor sensing that the item has been placed into the container and (ii) receive a response to the query from the RFID tag; and
a processor, operably coupled to the sensor and the RFID tag reader, to determine transaction data associated with the item based the response and to at least partially refund an amount based on the transaction data.

12. The system of claim 11, wherein the sensor comprises a camera configured to acquire image data showing the item being placed into the container.

13. The system of claim 11, wherein the sensor comprises a weight sensor configured to sense a change in weight of contents of the container.

14. The system of claim 11, wherein the sensor comprises a motion sensor configured to sense movement of the item into the container.

15. The system of claim 11, further comprising:
a user interface, operably coupled to the processor, to display information associated with the transaction data.

16. The system of claim 15, wherein the information associated with the transaction data comprises at least one of: a method of payment associated with the transaction data, information corresponding to a person associated with the transaction data, the amount at least partially refunded, or a date associated with the transaction data.

17. The system of claim 16, wherein the user interface is further configured to receive confirmation of the transaction data and/or an authentication.

18. A method comprising:
detecting, with at least one radio-frequency identification (RFID) tag reader, RFID tags moving through a store;
associating items affixed to the RFID tags with a cluster;
detecting a first item in the cluster at a point-of-sale system; and
providing an indication, via the point-of-sale system, of other items in the cluster to a person.

19. The method of claim 18, detecting the RFID tags moving through the store comprises:
transmitting interrogation signals, by the at least one RFID tag reader, to the RFID tags; and
detecting, by the at least one RFID tag reader, replies to the interrogation signals from the RFID tags.

20. The method of claim 19, wherein detecting the RFID tags moving through the store further comprises:
determining channel estimates for the RFID tags based on the replies; and
determining that the RFID tags are moving based on noise properties of the channel estimates and/or changes in the channel estimates over time.
